(19) United States
(12) Patent Application Publication
(10) Pub. No.: US 2025/0201221 A1
(43) Pub. Date: Jun. 19, 2025

(54) DETECTION SYSTEM AND KEYBOARD DEVICE

(71) Applicant: YAMAHA CORPORATION, Hamamatsu-shi (JP)

(72) Inventors: Shunsuke MIYOSHI, Iwata-shi (JP); Yuji TAKAHASHI, Hamamatsu-shi (JP); Naoki NISHIMURA, Hamamatsu-shi (JP); Hiroshi HARIMOTO, Hamamatsu-shi (JP)

(21) Appl. No.: 19/072,241

(22) Filed: Mar. 6, 2025

Related U.S. Application Data
(63) Continuation of application No. 18/359,471, filed on Jul. 26, 2023, now abandoned.
Application No. 18/359,471 is a continuation of application No. PCT/JP2022/005148, filed on Feb. 9, 2022.

(30) Foreign Application Priority Data
Feb. 22, 2021 (JP) 2021-025823

(51) Int. Cl. G10H 1/34; G10H 1/00

(52) U.S. Cl. CPC G10H 1/346; G10H 1/0008; G10H 2220/221; G10H 2220/281

(57) ABSTRACT

A detection system for a keyboard instrument includes a movable member that is displaceable in response to a user playing operation of the keyboard instrument. The detection system includes: (i) a detectable portion of a magnetic or conductive body that is disposed on the movable member; (ii) a detection board including: a detection coil disposed facing the detectable portion; and a detection circuit configured to generate a detection signal depending on a distance between the detection coil and the detectable portion; (iii) a control board, which is discrete from the detection board, including a control integrated circuit configured to generate, based on the detection signal, displacement data indicating a position of the movable member; and (iv) a transmitter configured to transmit the detection signal from the detection board to the control board.

### CROSS REFERENCE TO RELATED APPLICATIONS

This Application is a Continuation-In-Part Application of U.S. application Ser. No. 18/359,471, filed Jul. 26, 2023, which is a Continuation Application of PCT Application No. PCT/JP2022/005148 filed Feb. 9, 2022, and is based on and claims priority from Japanese Patent Application No. 2021-025823 filed Feb. 22, 2021, the entire contents of each of which are incorporated herein by reference.

### BACKGROUND

### Field of the Invention

This disclosure relates to techniques for detecting playing operations.

A variety of techniques have been proposed for detecting displacement of a movable member based on a playing operation by a user. For example, Japanese Patent Application Laid-Open Publication No. 2018-180074 (Patent Document 1) discloses a configuration in which sensors that detect displacement of corresponding keys of a keyboard instrument are disposed on a circuit board. An integrated circuit that processes detection signals of the sensors is disposed on the circuit board.

Since the sensors and the integrated circuit are disposed on one circuit board in the technique of Patent Document 1, reducing the size of the circuit board is limited.

### SUMMARY

In view of the circumstances described above, an object of one aspect of this disclosure is to reduce the size of a substrate on which elements for detecting displacement of movable members are disposed.

In order to solve the above problem, a detection system according to one aspect of this disclosure is a detection system for a keyboard instrument including a movable member that is displaceable in response to a user playing operation of the keyboard instrument. The detection system includes: a detectable portion of a magnetic or conductive body that is disposed on the movable member; a detection board including: a detection coil disposed facing the detectable portion; and a detection circuit configured to generate a detection signal depending on a distance between the detection coil and the detectable portion; a control board, which is discrete from the detection board, including a control integrated circuit configured to generate, based on the detection signal, displacement data indicating a position of the movable member; and a transmitter configured to transmit the detection signal from the detection board to the control board.

A detection system according to another aspect of this disclosure is a detection system for a keyboard instrument including a plurality of movable members, including a first movable member and a second movable member, that are displaceable in response to a user playing operation of the keyboard instrument. The detection system includes: a plurality of detectable portions each of a magnetic or conductive body, and including: a first detectable portion disposed on the first movable member; and a second detectable portion disposed on the second movable member; a detection board including: a first detection coil disposed facing the first detectable portion; a second detection coil disposed facing the second detectable portion; and a detection circuit configured to: generate a first detection signal depending on a distance between the first detectable portion and the first detection coil; and generate a second detection signal depending on a distance between the second detectable portion and the second detection coil; a control board, which is discrete from the detection board, including a control integrated circuit configured to: generate, based on the first detection signal, first displacement data indicating a position of the first movable member; and generate, based on the second detection signal, second displacement data indicating a position of the second movable member; and a transmitter configured to transmit the first detection signal and the second detection signal from the detection board to the control board.

A keyboard device according to one aspect of this disclosure includes: a plurality of keys including a first key and a second key; a plurality of detectable portions each of a magnetic or conductive body, and including: a first detectable portion disposed on the first key; and a second detectable portion disposed on the second key; a detection board including: a first detection coil disposed facing the first detectable portion; a second detection coil disposed facing the second detectable portion; and a detection circuit configured to: generate a first detection signal depending on a distance between the first detectable portion and the first detection coil; and generate a second detection signal depending on a distance between the second detectable portion and the second detection coil; a control board, which is discrete from the detection board, including a control integrated circuit configured to: generate, based on the first detection signal, first displacement data indicating a position of the first key; and generate, based on the second detection signal, second displacement data indicating a position of the second key; and a transmitter configured to transmit the first detection signal and the second detection signal from the detection board to the control board.

### BRIEF DESCRIPTION OF THE DRAWINGS

FIG. 1 is a plan view of a keyboard instrument according to a first embodiment.

FIG. 2 is a top plan view of a musical keyboard device as seen along the vertical direction.

FIG. 3 is a bottom plan view of the musical keyboard device as seen along the vertical direction.

FIG. 4 is a side view of a musical keyboard unit.

FIG. 5 is a circuit diagram showing a resonant circuit.

FIG. 6 is a block diagram showing an electrical configuration of the keyboard instrument.

FIG. 7 is a circuit diagram showing a configuration of an input filter.

FIG. 8 is a block diagram showing a configuration of a driving circuit.

FIG. 9 is a circuit diagram showing a configuration of an output filter.

FIG. 10 is a block diagram showing an internal configuration of a control IC.

FIG. 11 is a plan view of a coil according to a second embodiment.

FIG. 12 is a side view of a musical keyboard unit according to a third embodiment.

FIG. 13 is a block diagram showing an electrical configuration of a keyboard instrument 100 according to a fourth embodiment.

FIG. 14 is a schematic diagram of a strike mechanism according to a modification.

FIG. 15 is a schematic diagram of a pedal mechanism according to the modification.

### DESCRIPTION OF THE EMBODIMENTS

### A: First Embodiment

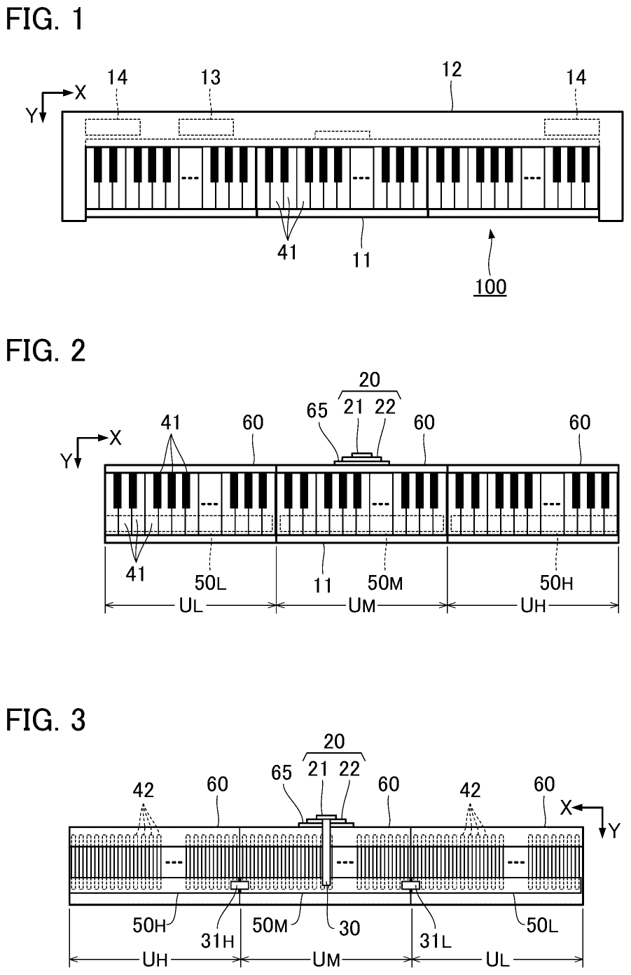

FIG. 1 is a plan view of a keyboard instrument 100 according to a first embodiment. The keyboard instrument 100 includes a musical keyboard device 11, a body 12, a sound source device 13, and a playback device 14. The body 12 is hollow. The body 12 supports and houses the musical keyboard device 11, the sound source device 13, and the playback device 14.

The musical keyboard device 11 includes keys 41 with white and black keys. The keys 41 are each operating elements that are vertically displaced by a playing operation (for example, pressing and releasing of the keys) performed by a user. The X-axis and Y-axis orthogonal to each other in a horizontal plane are assumed in the following explanations. The X-axis extends in the right-left direction of a user and the Y-axis extends in the front-back direction of the user. The keys 41 that are long in the Y-axis direction are arranged along the X-axis. The arrangement of the keys 41 constitutes a keyboard. The musical keyboard device 11 generates, for each of the keys 41, displacement data indicating a vertical position of the key 41.

The sound source device 13 generates an audio signal depending on the displacement data. Specifically, the sound source device 13 generates an audio signal representing sound with a pitch that corresponds to one of the different keys 41 pressed by a user among pitches corresponding to the keys 41. The playback device 14 is a sound speaker that outputs sound indicated by the audio signal. The playback device 14 (for example, a headphone set or an earphone set) constituted of a separate member from the keyboard instrument 100 may be connected to the keyboard instrument 100 either by wire or wireless.

FIG. 2 is a top plan view of the musical keyboard device 11 as seen along the vertical direction. FIG. 3 is a bottom plan view of the musical keyboard device 11 as seen along the vertical direction. The musical keyboard device 11 includes musical keyboard units U (UL, UM, and UH), a control board 20, a wiring portion 30, a relay 31L, and a relay 31H. The musical keyboard units U are independent from each other.

The musical keyboard units U (UL, UM, and UH) are coupled to each other along the X-axis. The musical keyboard unit UM is positioned between the musical keyboard units UL and UH. The musical keyboard unit UL includes keys 41 corresponding to a low range. The musical keyboard unit UM includes keys 41 corresponding to a middle range. The musical keyboard unit UH includes keys 41 corresponding to a high range. An example is given of a configuration in which each musical keyboard unit U includes the same number of keys 41 for convenience below. The total number of keys 41 may differ between the musical keyboard units U.

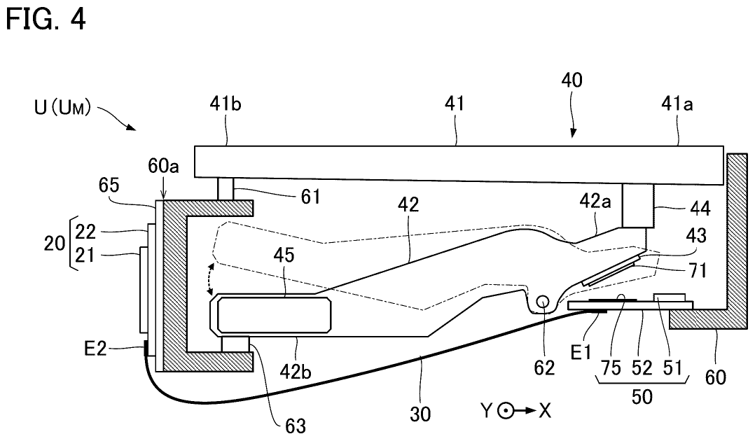

FIG. 4 is a side view showing a configuration of each of the musical keyboard units U. The configurations of the musical keyboard units U are the same. In FIG. 4, the configuration of the musical keyboard unit UM is shown for convenience. Each musical keyboard unit U includes operating mechanisms 40, a detection board 50, and a support part 60.

Each of the operating mechanisms 40 operates in response to a playing operation by a user, and includes a key 41 (a white or a black key), a weight member 42, and a detectable board 43. The weight member 42 and the detectable board 43 are disposed for each key 41. That is, each musical keyboard unit U includes the keys 41, and each key 41 includes the weight member 42 and the detectable board 43. The support part 60 is a frame that supports the operating mechanisms 40 and the detection board 50.

Each key 41 is a long member including a front end 41a and a rear end 41b and is supported by the support part 60 by way of a coupling portion 61 that acts as a fulcrum. The front end 41a is closer to a user playing the keyboard instrument 100, and the rear end 41b is on the opposite side to the front end 41a. The coupling portion 61 is elastically deformable to couple the rear end 41b to the support part 60. The front end 41a of each key 41 is vertically displaced by rotation of the key 41 on the coupling portion 61 that acts as a fulcrum. The displacement data indicates a vertical position of the front end 41a. A protrusion 44 that protrudes in the downward vertical direction is disposed on each of the keys 41.

The weight member 42 is a long member (a counterweight) including a front end 42a and a rear end 42b. The weight member 42 corresponding to each of the keys 41 is disposed below the corresponding key 41. The front end 42a is closer to a user, and the rear end 42b is on the opposite side to the front end 42a. A part of the weight member 42 between the front end 42a and the rear end 42b is pivotally supported by the support part 60. Specifically, the weight member 42 rotates on a rotation shaft 62 along the X-axis.

An adjustment weight 45 is disposed on the rear end 42b of the weight member 42. When a key 41 is not pressed, the rear end 42b of the corresponding weight member 42 is urged in the downward vertical direction by load of the adjustment weight 45. As a result, the weight member 42 is maintained in a state in which the rear end 42b is placed on a placement portion 63 (a stopper) disposed on the support part 60. When the front end 41a of a key 41 is lowered due to pressing by a user, the front end 42a of the corresponding weight member 42 is pressed by the protrusion 44, so that the weight member 42 rotates against the urging of the adjustment weight 45. That is, the front end 42a of the weight member 42 moves downward. As will be apparent from the description, the weight member 42 corresponding to each of the keys 41 is displaced depending on displacement of the corresponding key 41.

The detectable board 43 is disposed on each of the weight members 42. Specifically, the detectable board 43 is disposed on a lower surface of the front end 42a of the associated weight member 42. As a result, the detectable board 43 moves in response to a playing operation by a user. For example, the detectable board 43 moves vertically downward due to pressing of the corresponding key by a user and moves vertically upward by releasing of the key by the user. The displacement data indicates a vertical position of the front end 42a. The detectable board 43 is a circuit board on which a resonant circuit 71 is disposed. The resonant circuits 71 (the detectable boards 43), each of which corresponds to a different key 41, are arranged in the X-axis direction.

The detection board 50 is a long circuit board extending in the X-axis direction over the keys 41 in each musical keyboard unit U. The detectable board 43 is disposed for each key 41, and the detection board 50 is continuous over the keys 41. The detection board 50 is fixed to the support part 60 below the keys 41. The detection board 50 overlaps the keys 41, as seen in plan view from the vertical direction. Specifically, the detection board 50 overlaps the front ends 41a of the keys 41, as seen in plan view, and is fixed to the support part 60 below the weight members 42. More specifically, the detection board 50 is fixed to the support part 60 at a position closer to the front ends 41a of the keys 41 than the rear ends 41b. That is, the detection board 50 overlaps the weight members 42, as seen in plan view from the vertical direction. Specifically, the detection board 50 overlaps the front ends 42a of the weight members 42, on each of which the detectable board 43 is disposed, as seen in plan view. As a result, the detectable boards 43 and the detection board 50 oppose each other, and are vertically spaced apart from each other. Since the detection board 50 is disposed below the weight members 42 in the first embodiment, the detection board 50 can be disposed without interfering with displacement of the keys 41 or the weight members 42.

The detection board 50 includes resonant circuits 75, a detection circuit 51, and a wiring board 52. The wiring board 52 is a rigid substrate on which wires are formed on a surface or in the inner part thereof. The resonant circuits 75 and the detection circuit 51 are disposed on the wiring board 52.

Each musical keyboard unit U includes the detection board 50. Specifically, each musical keyboard unit U includes the wiring board 52. In the following description, the detection board 50 of the musical keyboard unit UL is referred to as “detection board 50L,” the detection board 50 of the musical keyboard unit UM is referred to as “detection board 50M,” and the detection board 50 of the musical keyboard unit UH is referred to as “detection board 50H,” in some cases. The detection board 50L, the detection board 50M, and the detection board 50H are different elements manufactured separately from each other. If the detection board 50 is a single substrate, a significantly long detection board 50 extending over all the keys 41 in the keyboard instrument 100 is required, and it is difficult to manufacture or handle the detection board 50. Since the keyboard instrument 100 according to the first embodiment includes the detection boards 50 that are discrete from each other, it is easier to manufacture or handle each of the detection boards 50.

The resonant circuits 75 are disposed for respective keys 41. The resonant circuits 75, each corresponding to a different key 41, are arranged in the X-axis direction. As will be apparent from the description, a set of the resonant circuit 71 and the resonant circuit 75 is disposed for each key 41.

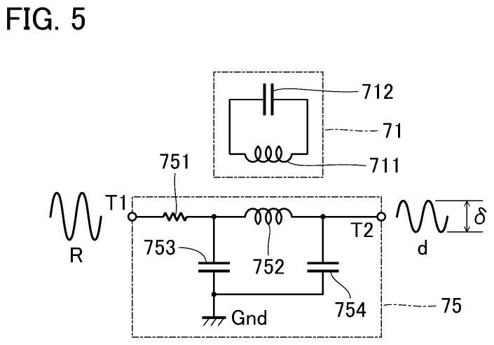

FIG. 5 is a circuit diagram including resonant circuits 71 and 75. The resonant circuit 71 includes a detectable coil 711 and a capacitor 712. Specifically, both ends of the detectable coil 711 and both ends of the capacitor 712 are wired to each other. That is, a first end of the detectable coil 711 is wired to a first end of the capacitor 712, and a second end of the detectable coil 711 is wired to a second end of the capacitor 712. The detectable coil 711 is composed of a conductive pattern that is formed on a surface or in the inner part of the corresponding detectable board 43. However, the detectable coil 711 may be wound by a conductive wire. As described above, the detectable coil 711 is disposed on the weight member 42. The detectable coil 711 is an example of a “detectable portion.” The detectable coil 711, the detection board 50, the control board 20, and the wiring portion 30 constitute a “detection system” for detecting a playing operation by a user. The musical keyboard device 11 may be understood as a “detection system.”

The resonant circuit 75 includes an input T1, an output T2, a resistor 751, a detection coil 752, a capacitor 753, and a capacitor 754. A first end of the resistor 751 is wired to the input T1 and a second end of the resistor 751 is wired to a first end of the capacitor 753 and a first end of the detection coil 752. A second end of the detection coil 752 is wired to the output T2 and a first end of the capacitor 754. A second end of the capacitor 753 and a second end of the capacitor 754 are grounded (Gnd). The detection coil 752 is composed of a conductive pattern that is formed on the detection board 50. The resonant frequency of the resonant circuit 71 is identical to that of the resonant circuit 75, but it need not be. The detection coil 752 may be wound by a conductive wire.

The detectable coil 711 and the detection coil 752 that correspond to one key 41 oppose each other, and are vertically spaced apart from each other. As described above, the detectable board 43 vertically moves in response to a playing operation by a user. As a result, a distance between the detectable coil 711 and the detection coil 752 changes in response to a playing operation by a user. Specifically, the distance between the detectable coil 711 and the detection coil 752 is decreased by pressing of a key by a user, and is increased by releasing of a key by the user.

A reference signal R is supplied to the input T1 of each of the resonant circuits 75. The signal level of the reference signal R changes periodically. The reference signal R may be a cyclic signal of a freely selected waveform, such as a sine wave. Furthermore, a frequency Fr of the reference signal R is set to a frequency substantially identical to the resonant frequencies of the resonant circuit 71 and the resonant circuit 75.

The reference signal R is supplied to the detection coil 752 through the input T1 and the resistor 751. A magnetic field is generated in the detection coil 752 by the supply of the reference signal R. The electromagnetic induction generated by the magnetic field in the detection coil 752 causes an induced current in the detectable coil 711 in the resonant circuit 71. That is, a magnetic field, which has a direction such that change in the magnetic field in the detection 20 coil 752 is cancelled, is generated in the detectable coil 711. Since the magnetic field in the detectable coil 711 changes depending on a distance between the detectable coil 711 and the detection coil 752, a detection signal d with an amplitude δ depending on the distance therebetween is output from the output T2 of the resonant circuit 75. The detection signal d is a cyclic signal, the level of which fluctuates with the frequency Fr identical to that of the reference signal R.

As shown in FIG. 4, the control board 20 is disposed on the support part 60 of the musical keyboard unit UM corresponding to the middle range from among the musical keyboard units U. That is, the support part 60 of the musical keyboard unit UM supports the associated keys 41, the detection board 50, and the control board 20. As shown in FIGS. 2 and 3, the control board 20 is not disposed on the musical keyboard unit UL and the musical keyboard unit UH. That is, the support part 60 of each of the musical keyboard units UL and UH supports the associated keys 41 and the detection board 50. The method of fixing the control board 20 to the support part 60 is freely selectable. For example, the control board 20 is fixed to the support part 60 by a freely selected structure, such as a screw, a snap-fit, a slide, or an engagement.

As shown in FIG. 4, the control board 20 is fixed to the support part 60 of the musical keyboard unit UM on the side of the rear ends 41b of the keys 41 of the musical keyboard unit UM. That is, the control board 20 is fixed to the support part 60 at a position closer to the rear ends 41b of the keys 41 than the front ends 41a thereof. Specifically, the control board 20 is disposed on a back surface 60a of the support part 60 of the musical keyboard unit UM, which is positioned near the rear ends 41b of the keys 41. As will be apparent from the above descriptions, the control board 20 does not overlap the detection board 50, in plan view as seen from the detection board 50.

Specifically, a fixing plate 65 is disposed on the back surface 60a of the support part 60 and the control board 20 is fixed to the surface of the fixing plate 65. That is, the control board 20 is indirectly fixed to the support part 60 with the fixing plate 65 interposed therebetween. The fixing plate 65 is, for example, a metallic plate member. The fixing plate 65 is formed into a specific shape by a known manufacturing method, such as sheet metal processing. The control board is electrically isolated from the fixing plate 65. The fixing plate 65 is positioned between the detection board 50 and the control board 20. By the above configuration, the fixing plate 65 functions as an electromagnetic shield. Accordingly, effects of the control board 20 on the magnetic field around the detection coil 752 are reduced.

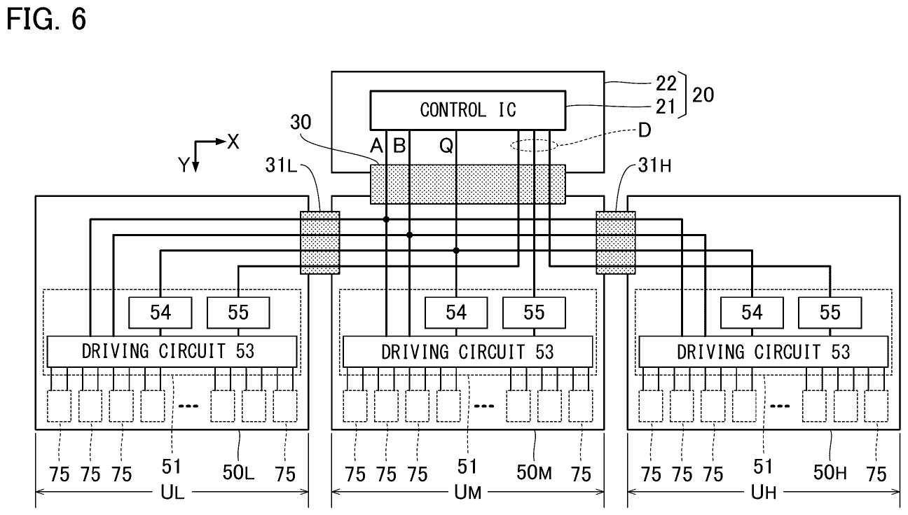

FIG. 6 is a block diagram showing an electrical configuration of the keyboard instrument 100. In FIG. 6, the wiring portion 30, the relay 31L, and the relay 31H are hatched for convenience. As shown in FIGS. 4 and 6, the control board 20 includes a control integrated circuit (IC) 21 and a wiring board 22. The wiring board 22 is a rigid substrate on which wires are formed on a surface or in the inner part thereof. The wiring board 22 is fixed to the back surface 60a of the support part 60 of the musical keyboard unit UM with the fixing plate 65 interposed therebetween. The control IC 21 is an integrated circuit (IC chip) mounted on the surface of the wiring board 22. Specifically, the control IC 21 is mounted on the surface of the wiring board 22 opposite to the support part 60 of the musical keyboard unit UM. A variety of mounting components, such as a resistor, a capacitor, a diode, a coil, a crystal oscillator, or a connector are mounted 15 on the surface of the wiring board 22, in addition to the control IC 21.

As will be apparent from the above descriptions, the control board 20 is constituted of a separate member from the detection boards 50 of the musical keyboard units U. Specifically, the wiring board 22 of the control board 20 is constituted of a separate substrate from the wiring boards 52 of the detection boards 50.

The wiring portion 30 is a mounting component for electrically connecting the detection board 50M of the musical keyboard unit UM to the control board 20. For example, a flexible cable such as an FFC (Flexible Flat Cable) or an FPC (Flexible Printed Circuit) is used as the wiring portion 30. The wiring portion 30 has a first end E1 and a second end E2. The first end E1 of the wiring portion 30 is wired to the detection board 50M (the wiring board 52). Specifically, the first end E1 of the wiring portion 30 is wired to a central part of the detection board 50M in the X-axis direction. The second end E2 of the wiring portion 30 is wired to the wiring board 22 of the control board 20. As shown in FIG. 4, the wiring portion 30 is positioned in a space below the keys 41 and the weight members 42.

The relay 31L in FIG. 6 is a mounting component for electrically connecting the detection board 50L of the musical keyboard unit UL to the detection board 50M of the musical keyboard unit UM. Specifically, a first end of the relay 31L is wired to the detection board 50L and a second end of the relay 31L is wired to the detection board 50M. The relay 31H is a mounting component for electrically connecting the detection board 50H of the musical keyboard unit UH to the detection board 50M of the musical keyboard unit UM. Specifically, a first end of the relay 31H is wired to the detection board 50H and a second end of the relay 31H is wired to the detection board 50M. The relay 31L and the relay 31H are flexible cables, such as an FFC or an FPC.

The detection board 50 (the wiring board 22) of each musical keyboard unit U includes the detection circuit 51 in addition to the multiple resonant circuits 75, each of which is disposed in a key 41. The detection circuit 51 is configured to generate a detection signal D depending on the distance between each of the detection coils 752 and the corresponding detectable coil 711 of the musical keyboard unit U. Specifically, the detection circuit 51 includes a driving circuit 53, an input filter 54, and an output filter 55.

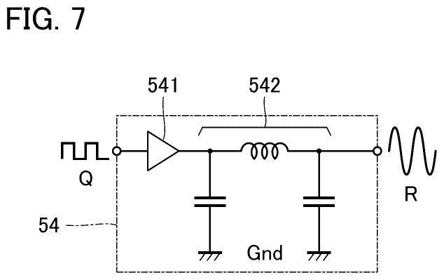

FIG. 7 is a circuit diagram showing a configuration of the input filter 54. A reference signal Q is supplied from the control IC 21 to the input filter 54. The reference signal Q is a cyclic signal, the level of which fluctuates with the frequency Fr. Specifically, the reference signal Q is a digital signal with a rectangular wave, the level of which fluctuates from a high level to a low level, and vice versa with the frequency Fr.

The input filter 54 is a circuit that generates the reference signal R from the reference signal Q, and includes an amplifier circuit 541 and a filter circuit 542. The amplifier circuit 541 amplifies the reference signal Q. The filter circuit 542 is a low-pass filter that generates the reference signal R by reducing high-pass signal components of the reference signal Q amplified by the amplifier circuit 541. For example, a x-filter including a coil, both ends of which are each wired to capacitors, is used as the filter circuit 542. The reference signal R generated by the input filter 54 is an analog signal, the level of which continuously changes. Specifically, the reference signal R is a cyclic signal with a wave similar to a sine wave. The reference signal R generated by the input filter 54 is supplied to the detection circuit 51.

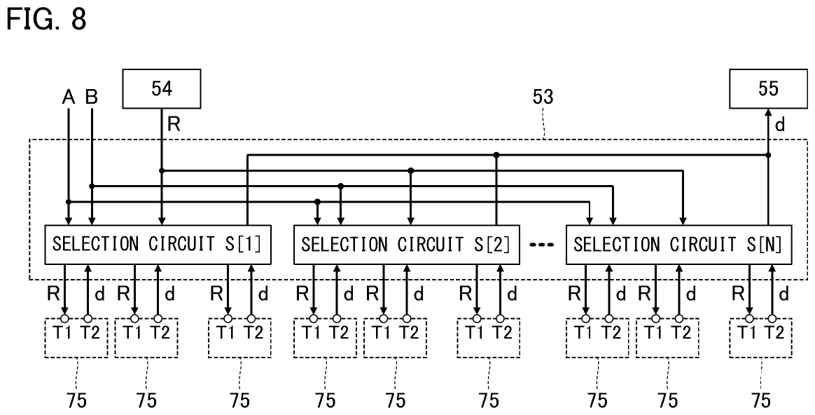

FIG. 8 is a block diagram showing a configuration of the driving circuit 53. The configuration of the driving circuit 53 is the same between the musical keyboard units U. The configuration shown in FIG. 8 is an example of the driving circuit 53. A freely selected circuit that outputs the detection signal d depending on the position of each of the keys 41 may be used as the driving circuit 53.

The driving circuit 53 includes a plurality of (N) selection circuits S[1] to S[N] (N is a natural number equal to or greater than 2). Each selection circuit S[n] (n=1 to N) is connected to the resonant circuits 75 corresponding to different keys 41. Each selection circuit S[n] is, for example, constituted of an IC chip mounted on the detection board 50. The driving circuit 53 may be constituted of a single IC chip. The number of the resonant circuits 75 corresponding to each selection circuit S[n] may differ depending on the selection circuit S[n].

Control signals A and B are supplied from the control IC 21 to each selection circuit S[n]. The control signal A is a signal that designates any of the N selection circuits S[1] to S[N] of the driving circuit 53 in each of the musical keyboard units U. Specifically, the control signal A designates each of the N selection circuits S[1] to S[N] one by one for each period (hereinafter, “selection period”) of a predetermined length. The control signal B is a signal that designates any of the resonant circuits 75 corresponding to one selection circuit S[n]. Specifically, in a selection period in which the selection circuit S[n] is selected, each of the resonant circuits 75 corresponding to the selected selection circuit S[n] is designated one by one by the control signal B.

The selection circuit S[n] selected by the control signal A selects each of the resonant circuits 75 corresponding to the selection circuit S[n] one by one by time division in synchronization with the control signal B, and supplies the reference signal R to the input T1 of the selected resonant circuit 75. The cycle of the reference signal R is sufficiently shorter than a period during which one resonant circuit 75 is selected by the selection circuit S[n]. The selection circuit S[n] supplies the detection signal d output from the output T2 of the selected resonant circuit 75 to the output filter 55. As will be apparent from the description, the detection signal d generated by each of the resonant circuits 75 is supplied to the output filter 55 one by one by time division with respect to each resonant circuit 75. The detection signal d is a cyclic signal, the level of which fluctuates with the frequency Fr identical to that of the reference signal R.

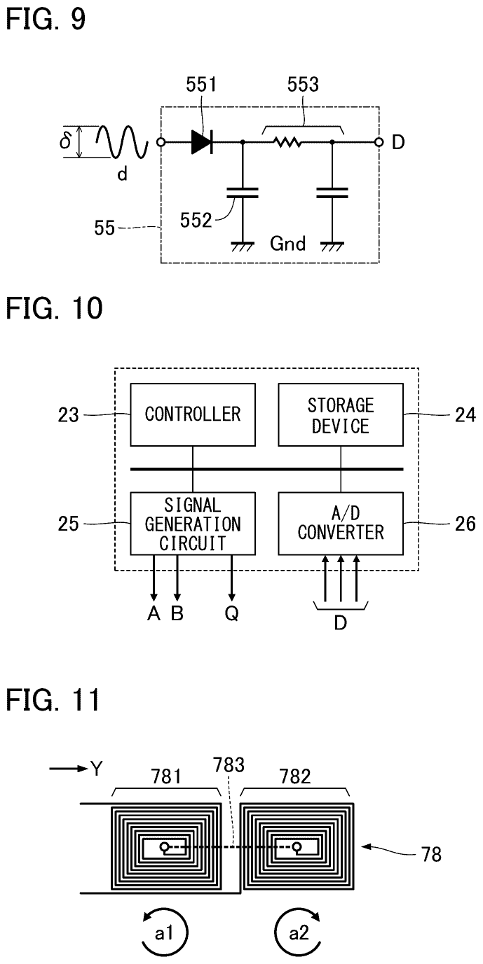

FIG. 9 is a circuit diagram showing a configuration of the output filter 55. The output filter 55 is a filter circuit that generates the detection signal D based on the detection signal d supplied from the driving circuit 53. Specifically, the output filter 55 includes a rectifier 551, a capacitor 552, and a low-pass filter 553.

The rectifier 551 is a diode that rectifies (half-wave or full-wave rectifies) the detection signal d. The capacitor 552 temporally smooths the detection signal d rectified by the rectifier 551. The low-pass filter 553 is constituted of a combination of a capacitor and a resistor, and generates the detection signal D by reducing high-pass signal components of the smoothed detection signal d. As will be apparent from the description, the detection signal D, the level of which fluctuates depending on the amplitude δ of each detection signal d, is generated. As described above, the amplitude δ of the detection signal d depends on the distance between the detectable coil 711 and the detection coil 752. As a result, the detection signal D is set to a signal level corresponding to the distance between the detectable coil 711 and the detection coil 752 by time division. The detection signals D are generated in parallel in the detection circuits 51 of the musical keyboard units U.

FIG. 10 is a block diagram showing an internal configuration of the control IC 21. The control IC 21 includes a controller 23, a storage device 24, a signal generation circuit 25, and an A/D converter 26. The control IC 21 may be constituted of a single IC chip, it or may be constituted of IC chips that are discrete from each other.

The controller 23 is constituted of one or more processors for controlling each of the elements of the keyboard instrument 100. Specifically, the controller 23 is constituted of one or more processors, such as a Central Processing Unit (CPU), a Sound Processing Unit (SPU), a Digital Signal Processor (DSP), a Field Programmable Gate Array (FPGA), or an Application Specific Integrated Circuit (ASIC).

The storage device 24 includes one or more memories that store programs executed by the controller 23 and data used by the controller 23. The storage device 24 is constituted of, for example, a known recording medium, such as a semiconductor recording medium. Execution of the program stored in the storage device 24 allows for the controller 23 to implement the functions of the sound source device 13. The sound source device 13, and the controller 23 that realizes the functions of the sound source device 13 act as a “playback controller,” which causes the playback device 14 to playback sound depending on the displacement data of each key 41.

The signal generation circuit 25 generates a variety of signals under the control of the controller 23. Specifically, the signal generation circuit 25 generates the control signal A, the control signal B, and the reference signal Q. Execution of the program stored in the storage device 24 allows for the controller 23 to implement the functions of the signal generation circuit 25.

The A/D converter 26 converts the detection signal D supplied from the detection circuit 51 of the associated musical keyboard unit U from an analog signal to digital data (hereinafter, “detection data”). The detection data, especially, a time series of the detection data is generated for each of the keys 41. The controller 23 generates the displacement data from the time series of the detection data for each of the keys 41.

The control signal A generated by the signal generation circuit 25 is transmitted from the control board 20 to the detection board 50M through the wiring portion 30, and is supplied to the detection circuit 51 (each selection circuit S[n]) of the detection board 50M. The control signal A transmitted from the control board 20 to the detection board 50M is transmitted from the detection board 50M to the detection board 50L through the relay 31L, and is supplied to the detection circuit 51 (each selection circuit S[n]) of the detection board 50L. Similarly, the control signal A transmitted from the control board 20 to the detection board 50M is transmitted from the detection board 50M to the detection board 50H through the relay 31H, and is supplied to the detection circuit 51 (each selection circuit S[n]) of the detection board 50H. That is, the control signal A is supplied in parallel to the detection circuits 51 of the musical keyboard units U. Similarly, the control signal B is supplied from the control board 20 to the detection circuit 51 of the detection board 50M through the wiring portion 30. The control signal B is supplied from the detection board 50M to the detection circuit 51 of the detection board 50L through the relay 31L, and is supplied from the detection board 50M to the detection circuit 51 of the detection board 50H through the relay 31H. That is, the control signal B is supplied in parallel to the detection circuits 51 of the musical keyboard units U.

The reference signal Q generated by the signal generation circuit 25 is transmitted from the control board 20 to the detection board 50M through the wiring portion 30, and is supplied to the detection circuit 51 (the input filter 54) of the detection board 50M. The reference signal Q transmitted from the control board 20 to the detection board 50M is transmitted from the detection board 50M to the detection board 50L through the relay 31L, and is supplied to the detection circuit 51 of the detection board 50L. Similarly, the reference signal Q transmitted from the control board 20 to the detection board 50M is transmitted from the detection board 50M to the detection board 50H through the relay 31H, and is supplied to the detection circuit 51 of the detection board 50H. That is, the reference signal Q is supplied in parallel to the detection circuits 51 (the input filters 54) of the musical keyboard units U.

The detection signal D generated by the detection circuit 51 of the detection board 50M is transmitted from the detection board 50M to the control board 20 through the wiring portion 30, and is supplied to the A/D converter 26 of the control IC 21. The detection signal D generated by the detection circuit 51 of the detection board 50L is transmitted from the detection board 50L to the detection board 50M through the relay 31L. The detection signal D transmitted from the detection board 50L to the detection board 50M is transmitted from the detection board 50M to the control board 20 through the wiring portion 30, and is supplied to the A/D converter 26 of the control IC 21. Similarly, the detection signal D generated by the detection circuit 51 of the detection board 50H is transmitted to the control board 20 through the relay 31H, the detection board 50M, and the wiring portion 30, and is supplied to the A/D converter 26 of the control IC 21. As described above, the detection signals D generated by the detection circuits 51 of the musical keyboard units U are supplied in parallel from the musical keyboard units U to the control board 20. The detection signal D generated by the detection circuit 51 of each of the detection board 50L and the detection board 50H is supplied to the control board 20 through the detection board 50M and the wiring portion 30.

As will be apparent from the description, the relay 31L transmits the detection signal D generated by the detection circuit 51 of the detection board 50L from the detection board 50L to the detection board 50M. Similarly, the relay 31H transmits the detection signal D generated by the detection circuit 51 of the detection board 50H from the detection board 50H to the detection board 50M. The wiring portion 30 is used to transmit the following to the control board 20: (i) the detection signal D generated by the detection circuit 51 of the detection board 50M, and (ii) the detection signals D transmitted to the detection board 50M from the detection board 50L and the detection board 50H. The detection board 50L and the detection board 50H are examples of a “first detection board” and the detection board 50M is an example of a “second detection board.” The detection circuit 51 of each of the detection board 50L and the detection board 50H is an example of a “first detection circuit” and the detection circuit 51 of the detection board 50M is an example of a “second detection circuit.”

In the first embodiment, the control IC 21 that is configured to generate the displacement data is disposed on the control board 20 that is discrete from the detection board 50 on which the detection coil 752 is disposed. As a result, it is easier to reduce the size of the detection board 50, for example, as compared to a configuration in which the control IC 21 is disposed on the detection board 50. Since it is easier to secure the distance between the detection coil 752 and the control IC 21 as compared to a configuration in which the control IC 21 is disposed on the detection board 50, effects of the control IC 21 on the magnetic field around the detection coil 752 are reduced. Accordingly, the displacement data can be generated with high accuracy. Particularly in the first embodiment, the control board 20 does not overlap the detection board 50 as seen in plan view. The distance between the detection coil 752 and the control IC 21 can be more easily secured as compared to a configuration in which the detection board 50 overlaps the control board 20 as seen in plan view. As a result, the influences of the control IC 21 upon the magnetic field around the detection coil 752 can be reduced, and the attained effect is significantly remarkable.

In the first embodiment, the detection signals D generated by the detection circuits 51 of the detection board 50L and the detection board 50H, and the detection signal D generated by the detection circuit 51 of the detection board 50M are supplied to the control board 20 through the wiring portion 30 between the detection board 50M and the control board 20. In the foregoing configuration, it is unnecessary to connect each of the detection board 50L and the detection board 50H directly to the control board 20. As a result, it is easier to reduce the size of the control board 20 as compared to a configuration in which each of the detection board 50L, the detection board 50M, and the detection board 50H is individually connected to the control board 20. However, each of the detection boards 50 (50L, 50M, and 50H) may be individually connected to the control board 20.

In the musical keyboard unit UM of the first embodiment, the detection board 50 and the control board 20 are supported by the support part 60 that is configured to support the keys 41. The configuration of the keyboard instrument 100 is simplified as compared to a configuration in which each of the detection board 50 and the control board 20 is supported by different structures from the support part 60 that supports the keys 41. Particularly in the first embodiment, the detection board 50 is disposed below the keys 41, and the control board 20 is disposed on the rear end side of the keys 41. In this configuration, it is easy to secure the distance between each of the detection coils 752 of the detection board 50 and the control IC 21 of the control board 20 despite the support of the detection board 50 and the control board 20 by the same support part 60. Effects of the control IC 21 on the magnetic field around the detection coils 752 can be effectively reduced. The detection board 50 and the control board 20 may be supported by different structures from the support part 60.

### B: Second Embodiment

A second embodiment will be described below. It is to be noted that in each of the embodiments described below, the same reference signs are used for elements having functions or effects identical to those of elements described in the first embodiment, and detailed explanations of such elements are omitted as appropriate.

FIG. 11 is a plan view of a coil 78 in the second embodiment. In the second embodiment, the coil 78 in FIG. 11 is used as either the detection coil 752 or the detectable coil 711. The rest of the configuration is substantially the same as that in the first embodiment. Therefore, substantially the same effects as those in the first embodiment are achieved in the second embodiment.

The coil 78 includes a first part 781, a second part 782, and a connecting part 783. Each of the first part 781 and the second part 782 is rectangular and spiral shaped. Each of the first part 781 and the second part 782 is a conductive pattern that forms a spiral wound counterclockwise outward from the center. The first part 781 and the second part 782 are adjacent to each other along the Y-axis. The connection part 783 is a conductive pattern formed in a different layer from that of the first part 781 and the second part 782. The connection part 783 electrically connects an end of the first part 781 at the center to an end of the second part 782 at the center.

By a supply of a current, a magnetic field is generated in each of the first part 781 and the second part 782. A direction a1 of a current flowing through the first part 781 opposes a direction a2 of a current flowing through the second part 782. Therefore, the magnetic fields in the opposite directions are generated in the first part 781 and the second part 782. By such a configuration, a magnetic field directed from the first part 781 to the second part 782, and vice versa, are generated. Accordingly, it is possible to limit or reduce leakage of the magnetic fields over to and across the keys 41 adjacent to each other in the X-axis direction. That is, interference of the magnetic fields between two coils 78 adjacent to each other is limited or reduced. As a result, it is possible to generate the detection signal d that highly accurately represents the position of each of the keys 41.

### C: Third Embodiment

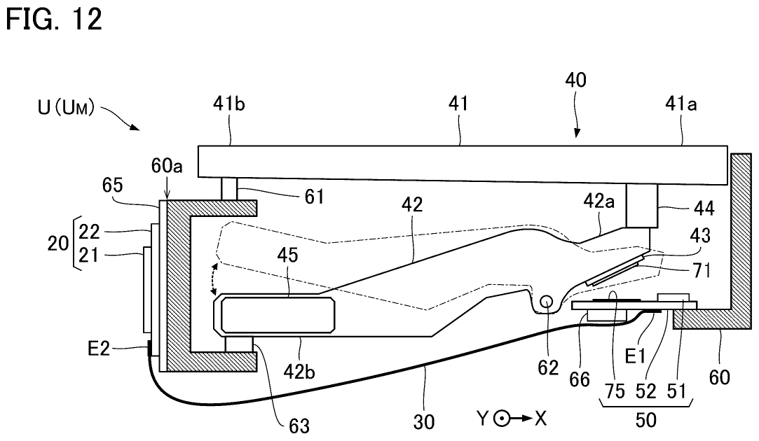

FIG. 12 is a side view showing a configuration of the musical keyboard units U according to a third embodiment. A spacer 66 is disposed on the detection board 50M of the musical keyboard unit UM in the third embodiment. The spacer 66 is a member that is interposed between the detection board 50M and the wiring portion 30 to secure a space therebetween. Specifically, the spacer 66 is positioned between a part of the wiring portion 30 other than the first end E1, which is wired to the detection board 50M, and the detection board 50M. The spacer 66 is made of an insulating material softer than that of the detection board 50 (the wiring board 52) and is deformable by pressing by one or both of the detection board 50M and the wiring portion 30.

In the third embodiment, substantially the same effects of the first embodiment are achieved. In a state in which the detection board 50M is excessively near the wiring portion 30, a signal transmitted by the wiring portion may affect the magnetic field around the detection coil 752. Since the spacer 66 is disposed between the detection board 50M and the wiring portion 30 in the third embodiment, a sufficient space is secured between the detection board 50M and the wiring portion 30. As a result, effects of the wiring portion 30 on the magnetic field around the detection coil 752 can be effectively reduced.

In the foregoing explanation, an example in which the spacer 66 is disposed between the detection board 50 and the wiring portion 30 has been described. However, the spacer 66 may be disposed between each of the detection boards 50 and the associated relay 31 (31L and 31H). In this example, a sufficient space is secured between the each of detection boards 50 and the relay 31. Accordingly, effects of the relay 31 on the magnetic field around the detection coil 752 can be effectively reduced.

### D: Fourth Embodiment

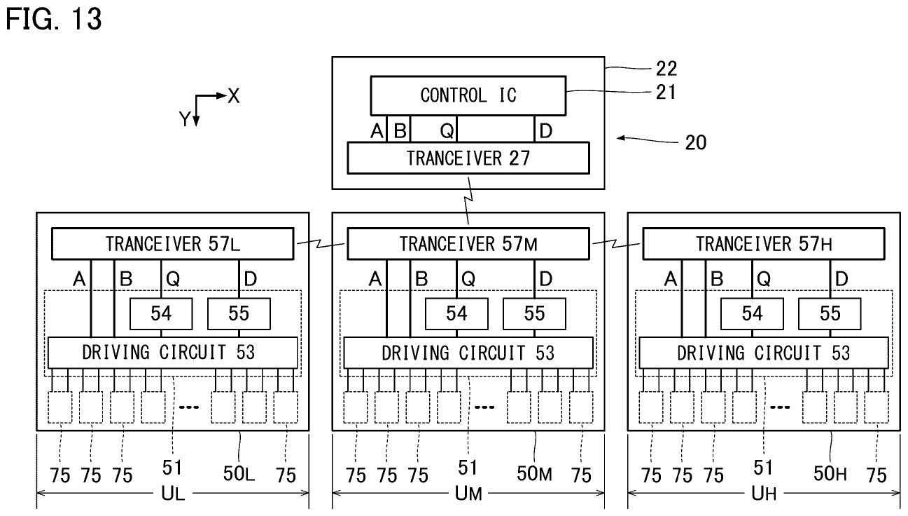

FIG. 13 is a block diagram showing an electrical configuration of a keyboard instrument 100 according to a fourth embodiment. In the first embodiment, the detection circuit 51 of the detection board 50M communicates with the control IC 21 via the wiring portion 30, communicates with the detection circuit 51 of the detection board 50L via the relay 31L, and communicates with the detection circuit 51 of the detection board 50H via the relay 31H. In the fourth embodiment, communication via the wiring portion 30 or the relay 31 (31L,31H) is replaced with radio communication. Accordingly, the wiring portion 30, the relay 31L, and the relay 31H in the first embodiment are omitted in the fourth embodiment.

The control board 20 includes a transceiver 27 in addition to the control IC 21 and the wiring board 22. Furthermore, each of the detection boards 50 (50L,50M,50H) includes a transceiver 57 (57L,57M,57H) in addition to the plurality of resonant circuits 75 and the detection circuit 51. The transceivers 27 and 57 are communication units capable of wireless communication. Specifically, the transceivers 27 and 57M can wirelessly communicate with each other. In addition, the transceivers 57M and 57L can wirelessly communicate with each other, and the transceivers 57M and 57H can wirelessly communicate with each other. The communication executed by the transceivers 27 and 57 is, for example, short-range radio communication, such as Bluetooth (registered trademark).

The control signals A and B generated by the signal generation circuit 25 of the control IC 21 are wirelessly transmitted from the transceiver 27 to the transceiver 57M, and are supplied to the detection circuit 51 (the respective selection circuits S[n]) of the detection board 50M. Furthermore, the control signals A and B received by the transceiver 57M are wirelessly transmitted from the transceiver 57M to the transceiver 57L, and are supplied to the detection circuit 51 (the respective selection circuits S[n]) of the detection board 50L. Similarly, the control signals A and B are wirelessly transmitted from the transceiver 57M to the transceiver 57H, and are supplied to the detection circuit 51 (the respective selection circuits S[n]) of the detection board 50H. As described above, also in the fourth embodiment, the control signals A and B are supplied in parallel to the detection circuits 51 of the musical keyboard units U as in the first embodiment.

Similarly, the reference signal Q generated by the signal generation circuit is wirelessly transmitted from the transceiver 27 to the transceiver 57M, and is wirelessly transmitted from the transceiver 57M to the transceivers 57L and 57H. That is, the reference signal Q is supplied in parallel to the detection circuits 51 (the input filters 54) of the musical keyboard units U.

The detection signal D generated by the detection circuit 51 of the detection board 50M is wirelessly transmitted from the transceiver 57M to the transceiver 27, and is supplied to the A/D converter 26 of the control IC 21. The detection signal D generated by the detection circuit 51 of the detection board 50L is wirelessly transmitted from the transceiver 57L to the transceiver 57M, and is then further from the transceiver 57M to the transceiver 27. Similarly, the detection signal D generated by the detection circuit 51 of the detection board 50H is transmitted to the transceiver 27 via the transceivers 57H and 57M. As described above, the detection signals D generated by the respective detection circuits 51 of the musical keyboard units U are supplied in parallel from the musical keyboard units U to the control board 20.

The transceiver 57M sequentially executes communication with the transceiver 27, communication with the transceiver 57L, and communication with the transceiver 57H by time division. That is, the transceiver 57M is shared for communication with the transceivers 27, 57L, and 57H. However, the transceiver 57M may include separate communication units for communication with the transceiver 27, communication with the transceiver 57L, and communication with the transceiver 57H.

In the fourth embodiment, the control board 20 and the detection board 50M do not need to be connected by the wiring portion 30. Also, the relay 31L connecting the detection board 50L to the detection board 50M and the relay 31H connecting the detection board 50M to the detection board 50H can be omitted. Therefore, according to the fourth embodiment, the configuration of the musical keyboard device 11 can be simplified as compared with the first embodiment. It is of note that the second embodiment or the third embodiment may be similarly applied to the fourth embodiment.

In the above explanation, the transceivers 57L and 57H communicate with the transceiver 27 via the transceiver 57M, but the transceiver 57L and 57H may communicate directly with the transceiver 27 without passing through the transceiver 57M.

The musical keyboard device 11 may include the wiring portion 30 and the relay 31 (31L,31H) of the first embodiment, and the transceiver 27 and the transceiver 57 (57L,57M,57H) of the fourth embodiment. In addition, transmission of signals by the wiring portion 30 and the relay 31 and transmission of signals by the transceiver 27 and the transceivers 57 may be selectively performed.

For example, in a state in which the transceivers 27 and 57M can communicate with each other, the transceivers 27 and 57M transmit and receive the signals A,B,Q,D by radio communication. On the other hand, in a state in which the transceivers 27 and 57M cannot communicate with each other due to degradation of the communication environment or the like, the control board 20 and the detection board 50M transmit and receive signals via the wiring portion 30. In a state in which the transceivers 57M and 57L can communicate with each other, the transceiver 57M and the transceiver 57L transmit and receive signals by radio communication, and in a state in which communication cannot be performed, the detection boards 50M and 50L transmit and receive signals via the relay 31L. The same applies to communication between the detection boards 50M and 50H.

### E: Modifications

Specific modifications added to each of the aspects described above are described below. Two or more aspects selected from the following descriptions may be combined with one another as appropriate as long as such combination does result in any conflict.
(1) In the foregoing embodiments, an example is shown of a configuration in which the control IC 21 is configured to generate the displacement data. However, the functions of the control IC 21 are not limited to such an example. The control IC 21 may have some of or all of the functions of the sound source device 13, or the control IC 21 may have a function of generating musical performance data in a MIDI format from the displacement data of each of the keys 41.
(2) In the foregoing embodiments, an example is shown of a configuration in which the control board 20 is disposed on the support part 60 of the musical keyboard unit UM. However, the place on which the control board 20 is disposed is not limited to the example. The control board 20 may be disposed on any of the members constituting the keyboard instrument 100. Specifically, the control board 20 may be disposed on any of the members included in the keyboard instrument 100, such as the body 12 of the keyboard instrument 100, a lid that is rotatably supported by the body 12 to cover the keyboard, or a keybed of the keyboard instrument 100.
(3) In the foregoing embodiments, the detectable coil 711 (the detectable board 43) is disposed on the weight member 42. However, the member (a movable member) on which the detectable coil 711 may be disposed is not limited to the above example. The detectable board 43 may be disposed on each of the keys 41. Other examples of the member on which the detectable coil 711 is disposed are described below.

### Mode A

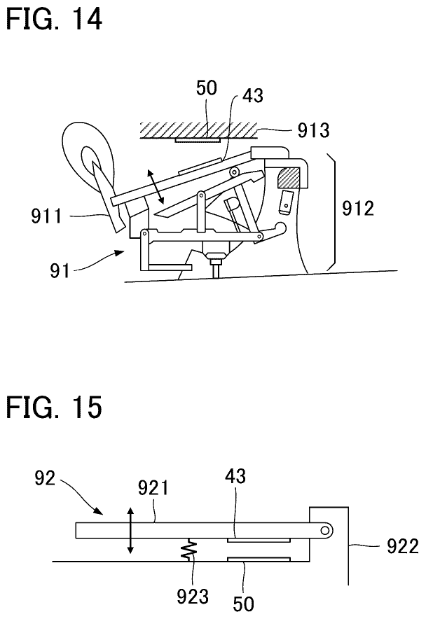

FIG. 14 is a schematic diagram showing a strike mechanism 91 of the keyboard instrument 100. As in an acoustic piano, the strike mechanism 91 strikes a string (not shown) in conjunction with a displacement of each key 41. Specifically, the strike mechanism 91 includes, for each key 41, a hammer 911 capable of striking a string by rotation and a transmission mechanism 912 (e.g., a whippen, a jack, and a repetition lever, etc.) that causes the hammer 911 to rotate in conjunction with the displacement of the key 41. In the configuration, the detectable board 43 is disposed on the hammer 911 (e.g., at a hammer shank). The detection board 50 is disposed on a supporting member 913. The supporting member 913 is a structure configured to support, for example, the strike mechanism 91. The detectable board 43 may be disposed on a member of the strike mechanism 91 other than the hammer 911.

### Mode B

FIG. 15 is a schematic diagram showing a pedal mechanism 92 of the keyboard instrument 100. The pedal mechanism 92 includes a pedal 921 operated by a user's foot, a supporting member 922 that supports the pedal 921, and an elastic body 923 that urges the pedal 921 in the upward vertical direction. In the above configuration, the detectable board 43 is disposed on the bottom of the pedal 921. The detection board 50 is disposed on the supporting member 922 such that the detection board 50 opposes the detectable board 43. A musical instrument for which the pedal mechanism 92 is used is not limited to the keyboard instrument 100. For example, the pedal mechanism 92 of substantially the same configuration may be used in a freely selected musical instrument, such as a percussion instrument.

FIG. 15 shows the pedal mechanism 92 of the keyboard instrument 100. However, substantially the same configuration as in FIG. 15 may be adopted as a pedal mechanism to be used in an electric musical instrument such as an electric string instrument (e.g., an electric guitar). The pedal mechanism used in an electric musical instrument is an effect pedal operated by a user to adjust a variety of sound effects, such as a distortion pedal or a compressor.

Each embodiment describes the keyboard instrument 100. However, an object to which this disclosure is applied is not limited to the above example. For example, substantially the same configuration as that in the above embodiments is adopted to detect the position of an operating element operated by a user at the time of playing of a wind instrument such as a woodwind instrument (e.g., a clarinet or a saxophone) or a brass instrument (e.g., a trumpet or a trombone).

As will be apparent from the above examples, an element on which the detectable board 43 is disposed is explained as a movable member that is displaced in response to a playing operation. The movable member includes an instrument playing element, such as the keys 41 or the pedal 921, directly operated by a user and also includes a structure, such as the weight member 42 or the hammer 911, displaced in conjunction with an operation performed on an instrument playing element. However, the movable member according to this disclosure is not limited to a member that is displaced in response to a playing operation. The movable member is explained as a displaceable member regardless of how displacement takes place.
(4) In the foregoing embodiments, an example is shown of a configuration in which the detectable coil 711 is disposed on the weight member 42. However, a member (hereinafter, “detectable body”) that is a magnetic body or a conductive body may be substituted for the detectable coil 711. An example is given of a metallic plate member as the detectable body. The magnetic field generated around the detection coil 752 fluctuates depending on the distance between the detection coil 752 and the detectable body. Accordingly, also in the configuration using the detectable body, the detection signal d depending on the distance between the detection coil 752 and the detectable body is output from the resonant circuit 75. As will be apparent from the above descriptions, the configuration in which the detectable body is disposed on a movable member is preferable, and the detectable coil 711 and the detectable body such as a metallic plate described above are examples of a “detectable portion.”
(5) In the foregoing embodiments, an example is shown of a configuration in which the keyboard instrument 100 includes the detection boards 50 (50L, 50M, and 50H) that are discrete from each other. However, the keyboard instrument 100 may include a single detection board 50. If a single detection board 50 is disposed, the detection board 50 corresponds to the “detection board.” If the detection boards 50 are disposed as in the examples of the above embodiments, a set of the detection boards 50 or any one of the detection boards 50 corresponds to the “detection board.”
(6) In the foregoing embodiments, an example is shown of a configuration in which the keyboard instrument 100 includes the sound source device 13. However, the sound source device 13 may be omitted if the keyboard instrument 100 has a sound producing mechanism such as the strike mechanism 91.

As will be apparent from the description, this disclosure may be considered to be an apparatus (a playing apparatus) that controls a musical sound by outputting to the sound source device 13 or the sound producing mechanism an operation signal in accordance with a playing operation. The concept of the playing apparatus includes not only an instrument (the keyboard instrument 100) provided with the sound source device 13 or the sound producing mechanism as described in each of the above embodiments, but also a device not provided with the sound source device 13 or a sound producing mechanism (e.g., a MIDI controller or the pedal mechanism 92 as described above). That is, the instrument playing apparatus according to this disclosure is explained as an apparatus operated by an instrument player (or an operator) to play an instrument.

### F: Appendices

The following configurations are derivable from the different embodiments described above.

A detection system according to one aspect (Aspect 1) of this disclosure is a detection system for a keyboard instrument including a movable member that is displaceable in response to a user playing operation of the keyboard instrument. The detection system includes: (i) a detectable portion of a magnetic or conductive body that is disposed on the movable member; (ii) a detection board including: a detection coil disposed facing the detectable portion; and a detection circuit configured to generate a detection signal depending on a distance between the detection coil and the detectable portion; (iii) a control board, which is discrete from the detection board, including a control integrated circuit configured to generate, based on the detection signal, displacement data indicating a position of the movable member; and (iv) a transmitter configured to transmit the detection signal from the detection board to the control board. According to one aspect or embodiment, the transmitter may comprise a wiring portion including a wiring configured to transmit the detection signal from the detection board to the control board. According to one aspect or embodiment, the transmitter may be configured to wirelessly transmit the detection signal from the detection board to the control board.

In this configuration, the control IC configured to generate displacement data is disposed on the control board that is discrete from the detection board on which the detection coil is disposed. As a result, it is easier to reduce the size of the detection board as compared to a configuration in which the control IC is disposed on the detection board. Furthermore, it is easier to secure the distance between the detection coil and the control IC as compared to the configuration in which the control IC is disposed on the detection board. Accordingly, effects of the control IC on a magnetic field around the detection coil are reduced. The displacement data can be highly accurately generated. The detection board includes one or more wiring boards. The control board also includes one or more wiring boards. The control IC comprises one or more integrated circuits (IC chips).

In a specific aspect (Aspect 2) according to Aspect 1, the control board is disposed spaced from the detection board and does not overlap the detection board, in a plan view as viewed from the detection board.

In this aspect, it is easier to secure the distance between the detection coil and the control IC as compared to a configuration in which the detection board overlaps the control board as seen in plan view. As a result, effects of the control IC on the magnetic field around the detection coil are reduced and the displacement data can be consequently generated with high accuracy.

In a specific aspect (Aspect 3) according to Aspect 1 or 2, the detectable portion includes a detectable coil disposed facing the detection coil.

In this aspect, electromagnetic induction generated by the magnetic field in the detection coil causes a current in the detectable coil. As a result, a magnetic field, which has a direction such that change in the magnetic field in the detection coil is cancelled, is generated in the detectable coil. A detection signal can be generated that reflects the distance between the detection coil and the detectable coil with high accuracy.

A detection system according to another aspect (Aspect 4) of this disclosure is a detection system for a keyboard instrument including a plurality of movable members, including a first movable member and a second movable member, that are displaceable in response to a user playing operation of the keyboard instrument. The detection system includes: (i) a plurality of detectable portions each of a magnetic or conductive body, and including: a first detectable portion disposed on the first movable member; and a second detectable portion disposed on the second movable member; (ii) a detection board including: (ii-1) a first detection coil disposed facing the first detectable portion; (ii-2) a second detection coil disposed facing the second detectable portion; and (ii-3) a detection circuit configured to: generate a first detection signal depending on a distance between the first detectable portion and the first detection coil; and generate a second detection signal depending on a distance between the second detectable portion and the second detection coil; (iii) a control board, which is discrete from the detection board, including a control integrated circuit configured to: generate, based on the first detection signal, first displacement data indicating a position of the first movable member; and generate, based on the second detection signal, second displacement data indicating a position of the second movable member; and (iv) a transmitter configured to transmit the first detection signal and the second detection signal from the detection board to the control board. According to one aspect or embodiment, the transmitter may be configured to wirelessly transmit the first detection signal and the second detection signal from the detection board to the control board.

The detection system in a specific aspect (Aspect 5) according to Aspect 4 further includes a spacer disposed on the detection board, in which the transmitter comprises a wiring portion that includes a wiring configured to transmit the first detection signal and the second detection signal from the detection board to the control board. A first end of the wiring portion is wired to the detection board, a second end of the wiring portion is wired to the control board, and the spacer is disposed between the detection board and part of the wiring portion other than the first end.

In this aspect, since the spacer is disposed between the detection board and the wiring portion, a sufficient space is secured between the detection board and the wiring portion. As a result, effects of the wiring portion on the magnetic field around the first detection coil or the second detection coil can be effectively reduced.

In a specific aspect (Aspect 6) according to Aspect 4, the detection board includes a first detection board and a second detection board that are discrete from each other. The first detection coil is disposed on the first detection board. The second detection coil is disposed on the second detection board. The detection circuit includes: a first detection circuit disposed on the first detection board and configured to generate the first detection signal; and a second detection circuit disposed on the second detection board and configured to generate the second detection signal.

In this aspect, the detection board includes the first detection board and the second detection board. As a result, it is easier to manufacture or handle the detection board as compared to a mode in which the detection board is constituted of a single substrate.

The detection system in a specific aspect (Aspect 7) according to Aspect 6 further includes a relay configured to transmit the first detection signal generated by the first detection circuit from the first detection board to the second detection board. The wiring portion transmits to the control board: the first detection signal from the first detection board to the second detection board through the relay; and the second detection signal generated by the second detection circuit.

In this aspect, the detection signal generated by the first detection circuit and the detection signal generated by the second detection circuit are transmitted to the control board through the wiring portion between the second detection board and the control board. Accordingly, it is unnecessary to electrically connect the first detection board to the control board. It is easier to reduce the size of the control board as compared to a configuration in which each of the first detection board and the second detection board is individually connected to the control board.

A keyboard device according to one aspect (Aspect 8) of this disclosure includes: (i) a plurality of keys including a first key and a second key; (ii) a plurality of detectable portions each of a magnetic or conductive body, and including: a first detectable portion disposed on the first key; and a second detectable portion disposed on the second key; (iii) a detection board including: (iii-1) a first detection coil disposed facing the first detectable portion; (iii-2) a second detection coil disposed facing the second detectable portion; and (iii-3) a detection circuit configured to: generate a first detection signal depending on a distance between the first detectable portion and the first detection coil; and generate a second detection signal depending on a distance between the second detectable portion and the second detection coil; (iv) a control board, which is discrete from the detection board, including a control integrated circuit configured to: generate, based on the first detection signal, first displacement data indicating a position of the first key; and generate, based on the second detection signal, second displacement data indicating a position of the second key; and (v) a transmitter configured to transmit the first detection signal and the second detection signal from the detection board to the control board. According to one aspect or embodiment, the transmitter may comprise a wiring portion including a wiring configured to transmit the first detection signal and the second detection signal from the detection board to the control board. According to one aspect or embodiment, the transmitter may be configured to wirelessly transmit the first detection signal and the second detection signal from the detection board to the control board.

In a specific aspect (Aspect 9) according to Aspect 8, the first key comprises at least two keys corresponding to a first range, from among the plurality of keys, and the second key comprises at least two keys corresponding to a second range different from the first range, from among the plurality of keys.

The keyboard device in a specific aspect (Aspect 10) according to Aspect 7 further includes a support part that supports (i) the plurality of keys, (ii) the detection board, and (iii) the control board.

In this aspect, by the support part that supports the keys, the detection board and the control board is supported. As a result, the structure of the keyboard device is simplified as compared to a configuration in which each of the detection board and the control board is supported by a different structure from the support part that supports the keys.

In a specific aspect (Aspect 11) according to Aspect 10, the detection board is disposed on the support part at a position closer to a front end of the first key than a rear end thereof and disposed below the first key. The control board is disposed on the support part at a position closer to a rear end of the second key than a front end thereof.

In this aspect, since the detection board is disposed below the keys and the control board is disposed closer to the rear end side of the keys, it is easier to secure the distance between each of the detection coils of the detection board and the control IC of the control board. As a result, effects of the control IC on the magnetic field around the detection coils are reduced. The “rear end side” of a key means a position closer to an end (a rear end) of both ends of a long key, which is opposite to an end (a front end) closer to an instrument player.

The keyboard device according to a specific aspect (Aspect 12) in Aspect 10 or 11 further includes a plurality of weight members that correspond to the respective plurality of keys. The plurality of weight members is disposed below the plurality of keys. Each of the plurality of weight members moves depending on displacement of one of the plurality of keys for the corresponding weight member. The detection board disposed on the support part below the plurality of weight members.

In this aspect, since the detection board is disposed below the weight members, the detection board can be disposed without interfering with displacement of the keys or the weight members.

### DESCRIPTION OF REFERENCE SIGNS

100 . . . keyboard instrument, 11 . . . musical keyboard device, 12 . . . body, 13 . . . sound source device, 14 . . . playback device, 20 . . . control board, 21 . . . control IC, 22 . . . wiring board, 23 . . . controller, 24 . . . storage device, 25 . . . signal generation circuit, 26 . . . . A/D converter, 27 . . . transceiver, 30 . . . wiring portion, 31 (31L and 31H) . . . relay, 40 . . . operating mechanism, 41 . . . key, 42 . . . weight member, 43 . . . detectable board, 44 . . . protrusion, 45 . . . adjustment weight, 50 (50L, 50M, and 50H) . . . detection board, 51 . . . detection circuit, 52 . . . wiring board, 53 . . . driving circuit, 54 . . . input filter, 55 . . . output filter, 57 (57L, 57M, and 57H . . . transceiver, 60 . . . support part, 61 . . . coupling portion, 62 . . . rotation shaft, 63 . . . placement portion, 65 . . . fixing plate, 66 . . . spacer, 71 and 75 . . . resonant circuit, 711 . . . detectable coil, 752 . . . detection coil.

What is claimed is:

1. A detection system for a keyboard instrument including a movable member that is displaceable in response to a user playing operation of the keyboard instrument, the detection system comprising:
a detectable portion of a magnetic or conductive body that is disposed on the movable member;
a detection board including:
a detection coil disposed facing the detectable portion; and
a detection circuit configured to generate a detection signal depending on a distance between the detection coil and the detectable portion;
a control board, which is discrete from the detection board, including a control integrated circuit configured to generate, based on the detection signal, displacement data indicating a position of the movable member; and
a transmitter configured to transmit the detection signal from the detection board to the control board.

2. The detection system according to claim 1, wherein the control board is disposed spaced from the detection board and does not overlap the detection board, in a plan view as viewed from the detection board.

3. The detection system according to claim 1, wherein the detectable portion includes a detectable coil disposed facing the detection coil.

4. The detection system according to claim 1, wherein the transmitter comprises a wiring portion including a wiring configured to transmit the detection signal from the detection board to the control board.

5. A detection system for a keyboard instrument including a plurality of movable members, including a first movable member and a second movable member, that are displaceable in response to a user playing operation of the keyboard instrument, the detection system comprising:
a plurality of detectable portions each of a magnetic or conductive body, and including:
a first detectable portion disposed on the first movable member; and
a second detectable portion disposed on the second movable member;
a detection board including:
a first detection coil disposed facing the first detectable portion;
a second detection coil disposed facing the second detectable portion; and
a detection circuit configured to:
generate a first detection signal depending on a distance between the first detectable portion and the first detection coil; and
generate a second detection signal depending on a distance between the second detectable portion and the second detection coil;
a control board, which is discrete from the detection board, including a control integrated circuit configured to:
generate, based on the first detection signal, first displacement data indicating a position of the first movable member; and
generate, based on the second detection signal, second displacement data indicating a position of the second movable member; and
a transmitter configured to transmit the first detection signal and the second detection signal from the detection board to the control board.

6. The detection system according to claim 5, further comprising:
a spacer disposed on the detection board,
wherein the transmitter comprises a wiring portion including a wiring configured to transmit the first detection signal and the second detection signal from the detection board to the control board,
wherein a first end of the wiring portion is wired to the detection board,
wherein a second end of the wiring portion is wired to the control board, and
wherein the spacer is disposed between the detection board and part of the wiring portion other than the first end.

7. The detection system according to claim 5, wherein:
the detection board includes a first detection board and a second detection board that are discrete from each other,
the first detection coil is disposed on the first detection board,
the second detection coil is disposed on the second detection board, and
the detection circuit includes:
a first detection circuit disposed on the first detection board and configured to generate the first detection signal; and
a second detection circuit disposed on the second detection board and configured to generate the second detection signal.

8. The detection system according to claim 7, further comprising:
a relay configured to transmit the first detection signal generated by the first detection circuit from the first detection board to the second detection board, wherein the wiring portion transmits to the control board:
the first detection signal from the first detection board to the second detection board through the relay; and
the second detection signal generated by the second detection circuit.

9. The detection system according to claim 5,
wherein the transmitter is configured to wirelessly transmit the first detection signal and the second detection signal from the detection board to the control board.

10. A keyboard device comprising:
a plurality of keys including a first key and a second key;
a plurality of detectable portions each of a magnetic or conductive body, and including:
a first detectable portion disposed on the first key; and
a second detectable portion disposed on the second key;
a detection board including:
a first detection coil disposed facing the first detectable portion;
a second detection coil disposed facing the second detectable portion; and
a detection circuit configured to:
generate a first detection signal depending on a distance between the first detectable portion and the first detection coil; and
generate a second detection signal depending on a distance between the second detectable portion and the second detection coil;
a control board, which is discrete from the detection board, including a control integrated circuit configured to:
generate, based on the first detection signal, first displacement data indicating a position of the first key; and
generate, based on the second detection signal, second displacement data indicating a position of the second key; and
a transmitter configured to transmit the first detection signal and the second detection signal from the detection board to the control board.

11. The keyboard device according to claim 10, wherein:
the first key comprises at least two keys corresponding to a first range, from among the plurality of keys, and
the second key comprises at least two keys corresponding to a second range different from the first range, from among the plurality of keys.

12. The keyboard device according to claim 10, further comprising a support part that supports:
the plurality of keys;
the detection board; and
the control board.

13. The keyboard device according to claim 12, wherein:
the detection board is disposed on the support part at a position closer to a front end of the first key than a rear end thereof and disposed below the first key, and
the control board is disposed on the support part at a position closer to a rear end of the second key than a front end thereof.

14. The keyboard device according to claim 12, further comprising:
a plurality of weight members that correspond to the respective plurality of keys,
wherein the plurality of weight members is disposed below the plurality of keys,
wherein each of the plurality of weight members moves depending on displacement of one of the plurality of keys for the corresponding weight member, and
wherein the detection board disposed on the support part below the plurality of weight members.
